(19) United States
(12) Patent Application Publication
(10) Pub. No.: US 2026/0073433 A1
(43) Pub. Date: Mar. 12, 2026

(54) SYSTEM AND METHOD FOR ESTIMATING A CHANGE IN BUDGET OF A CLOUD RESOURCE BASED ON ANTICIPATED RELEASES

(71) Applicant: Honeywell International Inc., Charlotte, NC (US)

(72) Inventors: Ankit Singh, Apex, NC (US); Lakshminarayana Paila, Frisco, TX (US)

(21) Appl. No.: 18/826,204

(22) Filed: Sep. 6, 2024

(51) Int. Cl. G06Q 30/0283

(52) U.S. Cl. CPC G06Q 30/0283

(57) ABSTRACT

The present disclosure provides a system and method for estimating cost of utilizing a cloud resource. The method involves identifying software tools associated with the cloud resource and, retrieving and aggregating programming data of the software tools. The method involves provides extracting metadata from a master dataset and parsing the metadata by a natural language model. Thereupon, by using a pricing calculator of the cloud resource a price report is generated. The price report can then be used for cost estimation, financial planning and raising alerts.

### TECHNICAL FIELD

Present disclosure relates to a system and a method for estimating cost of utilizing a cloud resource, and particularly, relates to planning, tracking and alerting regarding costs of utilizing cloud resource based on anticipated release of new features of a software product.

### BACKGROUND

Software product development nowadays involve continuous integration/continuous development (CI/CD) approach for integrating/programming/testing new capabilities. In a cloud-based environment, the software product will consume cloud resources which needs to be monitored for, inter alia, budgeting and cost estimation. However, existing systems for estimating cost of consuming the cloud resource lack capability of providing accurate financial monitoring. Also, tracking budget changes in existing system is challenging as the costs estimates are not available in real time and are usually out of date.

Existing systems for estimating costs of utilizing a cloud resource involve manually invoking a price calculator associated with the cloud resource and entering relevant pricing parameters each time a cost estimate is required. Such manual usage may not provide a proper cost estimate, as limited information is available and/or is provided by various development teams prior to such a calculation step. Further, because various Engineering/software tools are simultaneously used by various development teams, it can be a challenge to manually access and collate all relevant details regarding each tool, thereby leading to inaccurate estimates being provided for price calculations. It is a further challenge to estimate the costs when newer functionalities and enhancements are being developed for the software product since the resource utilization changes dynamically with each new functionality and enhancement.

Therefore, there remains a need for a solution for estimating cost for utilizing a cloud resource for efficient financial monitoring.

### SUMMARY OF THE INVENTION

In general, embodiments of the present disclosure herein provide a system and method for estimating cost of utilizing a cloud resource. Other implementations will be, or will become, apparent to one with skill in the art upon examination of the following figures and detailed description. It is intended that all such additional implementations be included within this description be within the scope of the disclosure and be protected within the scope of the claims.

In accordance with an embodiment of the present disclosure, an exemplary method for estimating cost of utilizing a cloud resource is provided. The method comprising identifying one or more software tool associated with the cloud resource, wherein the one or more software tool comprises programming data, retrieving the programming data of each of the one or more software tool; aggregating the programming data of each of the one or more software tool into a master dataset and extracting metadata from the master dataset, wherein the metadata comprises one or more fields relevant to utilizing the cloud resource. The method further comprises parsing the metadata, by a natural language model, to obtain one or more query parameter and inputting the metadata and each of the one or more query parameter into a pricing calculator of the cloud resource to generate a price report, wherein the price report is utilized to estimate the cost of utilizing the cloud resource.

In another embodiment, the present disclosure provides a system for estimating cost of utilizing a cloud resource. The system comprises one or more processor, a memory, and one or more programs stored in the memory, the one or more programs comprising instructions configured to identify one or more software tool associated with the cloud resource, wherein the one or more software tool comprises programming data, retrieve the programming data of each of the one or more software tool, aggregate the programming data of each of the one or more software tool into a master dataset and extract metadata from the master dataset, wherein the metadata comprises one or more fields relevant to utilizing the cloud resource. The one or more programs further comprising instructions configured to parse the metadata, by a natural language model, to obtain one or more query parameter and input the metadata and each of the one or more query parameter into a pricing calculator of the cloud resource to generate a price report, wherein the price report is utilized to estimate the cost of utilizing the cloud resource.

In yet another embodiment, the present disclosure provides a non-transitory computer-readable storage medium comprising computer program code for execution by one or more processors of an apparatus, the computer program code configured to, when executed by the one or more processors, cause the apparatus to identify one or more software tool associated with a cloud resource, wherein the one or more software tool comprises programming data, retrieve the programming data of each of the one or more software tool, aggregate the programming data of each of the one or more software tool into a master dataset and extract metadata from the master dataset, wherein the metadata comprises one or more fields relevant to utilizing the cloud resource. The one or more processors, further cause the apparatus to parse the metadata, by a natural language model, to obtain one or more query parameter and input the metadata and each of the one or more query parameter into a pricing calculator of the cloud resource to generate a price report, wherein the price report is utilized to estimate a cost of utilizing the cloud resource.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a block diagram of a system for estimating cost of utilizing a cloud resource, in accordance with an embodiment of the present disclosure;

FIG. 2 illustrates a flow chart of the steps executed for estimating cost of utilizing a cloud resource, in accordance with an embodiment of the present invention;

FIG. 3 illustrates a block diagram of a system for identifying all software tools which are associated with the cloud resource, extracting programming data of the software tools and combining the extracted programming data to form a master dataset, in accordance with an embodiment of the present disclosure;

FIG. 4 illustrates a flow chart of the steps executed for identifying all software tools which are associated with the cloud resource, extracting programming data of the software tools and combining the extracted programming data to form a master dataset, in accordance with an embodiment of the present invention;

FIG. 5 illustrates a block diagram of a system for generation of a master query by extraction of metadata and parsing it to generate query parameters, in accordance with an embodiment of the present disclosure;

FIG. 6 illustrates a flow chart of the steps executed for generation of a master query by extraction of metadata and parsing it to generate query parameters, in accordance with an embodiment of the present disclosure;

FIG. 7 illustrates a block diagram of a system for generation of price report relating to utilization of a cloud resource and providing overall financial monitoring of the cloud resource charges, in accordance with an embodiment of the present disclosure;

FIG. 8 illustrates a flow chart of the steps executed for generation of price report relating to utilization of a cloud resource and providing overall financial monitoring of the cloud resource charges, in accordance with an embodiment of the present disclosure;

FIG. 9 illustrates a user interface for cost estimation of utilizing a cloud resource, in accordance with an embodiment of the present invention.

FIG. 10 illustrates a typical cost report generated by the price calculator of a cloud resource, in accordance with an embodiment of the present invention.

FIG. 11 illustrates a block diagram of a system for generation of price report of multiple cloud resources and comparison amongst the price report of multiple cloud resources, in accordance with an embodiment of the present invention; and

FIG. 12 illustrates a flow chart of the steps executed for generation of price report of multiple cloud resources and comparison amongst the price report of multiple cloud resources, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components, and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment). The terms “cost”, “price”, budget”, “charges” may be used herein interchangeably.

The word “example” or “exemplary” is used herein to mean “serving as an example, instance, or illustration.” Any implementation described herein as “exemplary” is not necessarily to be construed as preferred or advantageous over other implementations.

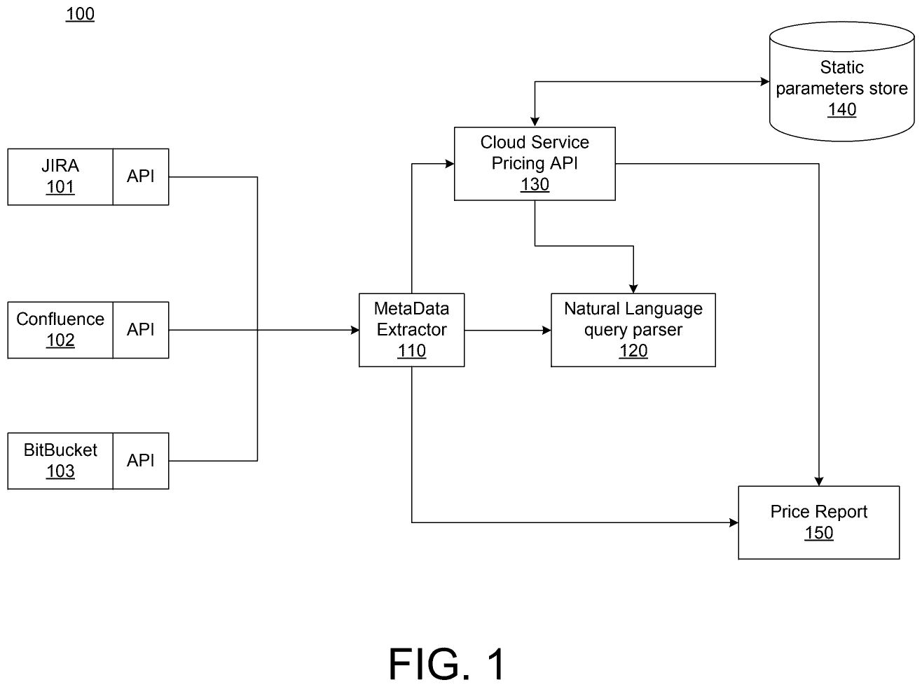

FIG. 1 illustrates a block diagram of a system for estimating cost of utilizing a cloud resource in accordance with an embodiment of the present invention. The implementation of the system 100 proposed in the present invention involves providing a cost estimate of using cloud resources in view of existing as well as new functionalities being developed. The system 100 identifies all software tools which are associated with the cloud resource. Each software tool may have data corresponding to programming performed by software developers. The data corresponding to the programming is extracted and then combined to form a master dataset. Thereupon, the system 100 extracts metadata from the master dataset and the metadata is parsed by a natural language model, to obtain query parameters. The system 100 proposed in the present invention then inputs the metadata and the query parameters to a pricing calculator of the cloud resource to generate a price report. The generated price report can then be utilized to estimate the cost of utilizing the cloud resource, track budgets, raise alerts etc.

Most of the current implementations of a software product consume cloud resources and such consumption incur costs payable to provider of the cloud resources. Further, as developers keep on adding or upgrading existing software product with newer functionalities, the cost of utilizing cloud resources keep on increasing. The system 100 proposed in the present invention identifies all software tools which developers are using to add new functionalities. The software tools like JIRA, Confluence, Bitbucket, Lucid Charts, MIRO boards etc., are typically used by developers. The coding or programming data within these software tools can provide details regarding the utilization of the cloud resources as expected upon implementation of the programming data of these software tools.

The system 100 involves identification of relevant software tools which may be associated with utilization of cloud resource. Such identification is critical, as not all software tools may have programming data relevant to utilization of cloud resource. Therefore, only those software tools having programming data about utilization of cloud resource are relevant for the present system 100. This identification can be based on a look-up table providing such details about each software tool. Alternatively, this identification may be made by querying each software tool and retrieving this information. Once all relevant software tools associated with the cloud resource are identified, the system 100 then retrieves the programming of each of these software tools.

The implementation of the system 100 proposed in the present invention involves that the programming data of each of the software tool is retrieved by their respective Application Programming Interface (API). FIG. 1 illustrates exemplary software tools JIRA 101, Confluence 102 and BitBucket 103 along with their respective APIs. The present discourse is not limited to only these three software tools and their APIs and, any other software tool associated with utilizing the cloud resource will be of relevance. Further, as per FIG. 1, the programming data of these various software tools is being retrieved by their respective APIs, however, the invention is not limited to retrieval of programming data via APIs and any other method or technique of retrieving the programming data of the software tools may be utilized. For each software tool from which the programming data is being retrieved, a corresponding API will have to be configured. The API for the extracting can be pre-defined or may be customized for the present implementation and the present invention is not limited by the implementation or configuration of the API of the software tool.

Once the programming data of each of the identified software tool is retrieved, the implementation of the system 100 proposed in the present invention involves combining the programming data of each of the identified software tool. In one embodiment, the retrieval and aggregation of the programming data is done using TF-IDF algorithms. Additionally, other Topic modelling techniques may be implemented according to various other embodiments. Such algorithms/technique can extract data based on correlation with the cloud resource. Depending upon the software tool from which the data is being retrieved, different topic modelling techniques may be utilized and the present invention is not limited to a particularly extraction or retrieval algorithm/technique. The combining or aggregating the programming data allows forming of a large dataset of the programming data from various software tools. This large dataset contains information regarding the new functionalities being added and can then be utilized to estimate costs of utilizing cloud resources, as explained hereinafter.

The large (or master) dataset, obtained by retrieving and aggregating of programming data, is utilized for extracting metadata, by metadata extractor 110 as shown in FIG. 1. The metadata contains information relevant to utilization of the cloud resource. This is important as the master dataset may contain programming data of various software tools, however, not the whole programming data will be relevant for the utilization of cloud resource. Therefore, this extraction of metadata ensures that only relevant information relating to utilization of cloud resource is captured. FIG. 1 shows the extraction of metadata after aggregation of programming data into a master dataset, however the present invention is not limited to placement of the metadata extractor 110. In an alternative embodiment, metadata of programming data of each of software tool is first extracted and then the aggregation is performed. In still an alternative embodiment, the APIs directly provide metadata of the programming data of each software tool and a separate module for extraction of metadata is not required.

In an embodiment of the present invention, the metadata can be used for estimating cost of utilizing the cloud resource. As the metadata comprises information relevant to estimating cost of utilizing the cloud resource, the metadata can be fed to a price calculator of the cloud resource to obtain a cost estimate. The metadata may provide values of the fields of the price calculator like location/region, number of entries to be reviewed for a given time, number of severs, number of hours of use per server etc. Depending upon the type of service of the cloud resource is being availed, the price calculator will ask for corresponding inputs to provide a cost estimate and such input values are provided from the metadata. For instance, a migration service cloud resource will have different inputs and a different price calculation logic as compared to use of AI/ML service cloud resource. Depending upon the values present in the metadata, the price calculator of the cloud resource can be used to generate the cost estimate.

In an embodiment of the present invention, the price calculator of the cloud resource can be accessed by a Cloud Service Pricing API 130, as shown in FIG. 1. The Cloud Service Pricing API 130 provides an interface to the price calculator of the cloud resource and the price calculator has not been depicted separately in FIG. 1. The system 100 of FIG. 1 obtains the cost estimate by invoking the price calculator using Cloud Service Pricing API 130 and inputting the metadata to the Cloud Service Pricing API 130. Based on this input, the Cloud Service Pricing API 130 provides cost estimate, typically in a form a cost report. The obtained cost report can then be used for estimation, planning, raising alerts etc., as desired. The API to invoke a price calculator of the cloud resource is typically provided with necessary documentation for invoking or using the API. In an alternative embodiment, the price calculator may be built within the metadata extractor module 110 and an API will not be required for accessing the price calculator of the cloud resource.

The Cloud Service Pricing API 130 generates the cost report based on the metadata as input, in an embodiment of the present invention. In another embodiment, in addition to the metadata provided by the metadata extractor 110, some static parameters are also inputted to the Cloud Service Pricing API 130 by the static parameter store 140. Such static parameters may be some standard values like region, number of months, number of logins etc., which may be fixed and pre-defined for user of a given organization. Accordingly, depending upon the user accessing the price calculator, static fields can be fetched from the static parameter store 140 and dynamic fields are provided by the metadata. The fields in the static parameter store 140 can be separately updated by the user and the invention is not limited to the implementation, update or access of the static parameter store 140. Still further, the fields from the static parameter store 140 may not be used for a given user or a given type of functionality for which price calculator is being invoked.

In an embodiment of the present invention, the metadata is fed as input to the Cloud Service Pricing API 130. In another embodiment, the metadata is parsed by a Natural Language Query Parser 120 as shown in FIG. 1. While the metadata extracted contains relevant invention regarding utilization of the cloud resource, the same may not be comprehensible to be directly fed into the pricing calculator of the cloud resource to obtain the cost estimate. Therefore, the metadata can be parsed by the Natural Language Query Parser 120 to obtain more comprehensible data which can then be inputted to the price calculator to obtain the cost estimate. The Natural Language Query Parser 120 can be based on any trained large language model (LLM) which is able to comprehend the metadata. Still further, the LLM may be particularly trained on the language of the software tools to allow the Natural Language Query Parser 120 to accurately parse the metadata. The parsed metadata directly provides query parameters to be inputted to the price calculator. In this embodiment, the system 100 obtains the cost estimate by invoking the price calculator using Cloud Service Pricing API 130 and, inputting the metadata and the query parameters (obtained by parsing the metadata) to the Cloud Service Pricing API 130. Based on these inputs, the Cloud Service Pricing API 130 will provide a cost estimate, typically in a form a cost/price report. The obtained cost report can then be used for estimation, planning, raising alerts etc., as desired.

The Cloud Service Pricing API 130 provides cost estimate as output in the form of cost report. The report may be a spreadsheet providing details of the functionality or service of the cloud resource and corresponding budget, in a given currency. The format of the cost report may be modified at the end of the price calculator or at user end to meet the requirement of the system 100. The cost report may also have additional fields providing further details regarding the services and their budgets. For instance, the report may have details of the services of the cloud resource like, migration, gateway, watch services and their corresponding charges in a given currency. The report may also group similar or related services together, or in same color for ease of view and identification. The present invention is not limited by the format or presentation of the report and any suitable format may be utilized for the reporting.

The cost report may have multiple sheets providing not only the current, but also historical budgets to provide user with additional information. Also, the price report will not only be available for viewings, but can also be saved by the system 100 in a desired format like excel sheet, word file, pdf etc. Each file can be duly timestamped providing ease of future access and identification. Also, the price report format may be dependent on the user, being pre-set for each user. This will provide each user with price report in a format as desired hence, providing only relevant information as well as ease of access.

Once the price report is generated by the system 100 of FIG. 1, the same can be used in variety of manners to achieve better financial tracking and planning for budgeting a cloud resource. Firstly, the cost report can be used for estimating charges of utilizing the cloud resource. The cost report generated, as per the system 100 of FIG. 1, are based on programming data of various software tools. Therefore, charges mentioned in the cost report can provide an indication of the charges which may occur for utilizing the cloud resource with the given programming data of the software tools. As the APIs of the software tools provide an UpToDate and instantaneous programming data, the cost report generated can also provide a latest budget estimate. Such implementation is superior as compared to conventional systems, which rely on manual generation of cost report based on programming data provided by the programmers and may not be most accurate and/or UpToDate. Particularly, as the programming data is directly fetched from the software tools, there is no scope of human error, as compared to conventional systems in which programmer would provide the programming data for cost estimation. Still further, the APIs of the software tools and of the pricing calculator can be invoked when desired and provide the cost estimate in a timely manner. The system 100 can also be configured to periodically run the APIs and obtain cost report, say on a monthly basis.

The cost report can also be used for tracking and planning the budget of utilizing a cloud resource. By comparing the previous and current cost report, a user can track a change in the costs and/or estimated budget. For example, if the previous allocated budget before calculation was $4000 for a given period, but based on latest programming data with new service, the total budget is $6000, then an increase of $2000 in the budget can be anticipated. The change may be tracked for the total budget or for budget of any particular service within the cost report. The user may even compare multiple previous cost report to monitor trends and use them to project future costs. Any unreasonable increase in the budget can be reported and/or analyzed further, as desired. Such increase in the budget can also be used for triggering alert(s) to concerned users. Such users may typically be finance in-charge, project manager, planning in-charge etc. The criteria for the alerts may be pre-set within the system. For instance, alerts may be triggered based on more than 20% increase in cost, crossing of a capping limit etc. Also, the alerts may be for a particular service within the cost report and may not be triggered for all services even if they exceed the limit. These alerts can be placed for some specific services which are in high demand, like AI/ML so as to better plan the budget for such services only.

The change in budget in different cost report can also allow a user to track new features which the developers may be implementing and which will consume the cloud resource. Accordingly, in an embodiment of the present invention, a change in budget may be used for identifying new features being implemented. Particularly, in case there is an increase in budget based on a cost report generated by the system 100, further analysis may be performed for identifying the applicable feature(s) of a software product, responsible for this budget increase. Such tracking applicable feature(s) of the software product may also be implemented in the form of alerts to some targeted users, like development head, testing head etc.

The cost report can further be used for updating the budget allocation for utilizing the cloud resource. For instance, based on a latest cost report it is identified that the projected budget will increase substantially, the budget allocation for the cloud resource itself can be updated so that the cloud services can continue without any issue of the increased costs. Particularly, in view of the estimated increase, necessary budget approvals can be timely obtained so that cloud services are be continuously used without interruption.

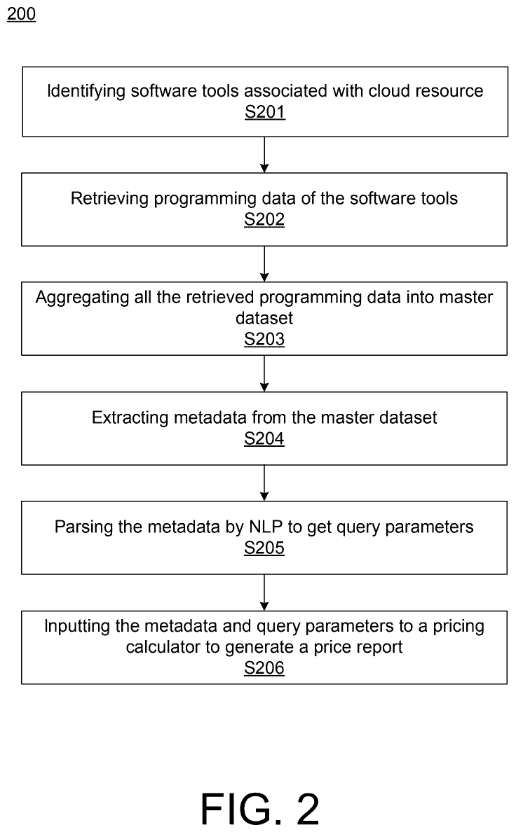

FIG. 2 illustrates the steps executed by a method for estimating cost of utilizing a cloud resource, in accordance with an embodiment of the present invention. Firstly, at step S201, software tool associated with the cloud resource are identified. There may be plurality of software tools like JIRA, Confluence, Bitbucket, Lucid Charts, MIRO boards etc., which are associated with the cloud resource utilization and each of the software tools which are associated with the cloud resource are identified at step S201. Each of the software tool may be independent and unrelated to other software tools. Also, each of software tool comprises data providing details regarding the programming done by software developers. Particularly, developers/programmers add newer functionalities to an existing software product and when such newer functionalities are implemented, it can impact the cost of utilizing cloud resources. Programming data of these software tools can provide details regarding the utilization of the cloud resources as expected upon implementation of this programming data of these software tool. Identification of relevant programming tool at step S201 is critical as not all software tools will have programming data relevant to utilization of the cloud resource. Software tools having programming data about utilization of cloud resource are relevant for the present method and such identification may be made by querying each software tool and retrieving this information. The identification step may alternatively be based on look-up table providing relevant details about each software tool.

Once all relevant software tools associated with the cloud resource are identified, the method then retrieves programming data from each of these software tools at step S202. The programming data of each of the software tool may be retrieved by their respective API. For each software tool from which the programming data is being retrieved, a corresponding API will have to be configured. The API for the extracting can be pre-defined or may be customized for the present implementation and the present invention is not limited by the implementation or configuration of the API of the software tool. Alternatively, the programming data of each of the software tool may be retrieved from a copy of the programming data of the software tool directly available for access by the present method and the present invention is not limited by the procedure relating to the retrieval of the programming data.

Upon retrieval of the programming data of each of the identified software tool, the method involves aggregating all the retrieved programming data into master dataset at step S203. The aggregating or combining of the programming data ensures forming of a large dataset of the programming data from various software tools. Such large/master dataset provides information regarding any new functionalities being added to a software product and can then be utilized to estimate costs of utilizing the cloud resources. In an embodiment of the present invention, the step of retrieval and combining may be performed together. Also, the retrieval and aggregation of the programming data can be done using TF-IDF algorithms or any other Topic modelling techniques. The extraction of data can be based on correlation with the cloud resource. Depending upon the software tool from which the data is being retrieved, different topic modelling techniques may be utilized and the present invention is not limited to any particularly extraction or retrieval algorithm/technique.

Upon aggregating of the programming data of each of the identified software tool into a master dataset, the method 200 involves extracting metadata from the master dataset at step S204. The metadata contains information relevant to utilization of the cloud resource. This step is needed since the master dataset may contain programming data, which may not be relevant for the utilization of the cloud resource. Therefore, this step of extraction of metadata ensures that only relevant information relating to utilization of cloud resource is captured. In an embodiment of the present disclosure, the extraction of metadata is not performed after aggregation of programming data into a master dataset as shown in FIG. 2, rather the retrieval of programming data of each of the software tool also involves metadata extraction as well. In an alternative embodiment, the APIs directly provide metadata of the programming data of each software tool and a separate step for extraction of metadata is not required.

Once the metadata is extracted, the next step S205 is parsing of the metadata by a natural language model, to obtain one or more query parameter. This step is performed as even though the metadata extracted contains relevant invention regarding utilization of the cloud resource, the same may not be comprehensible for cost estimation using a pricing calculator of the cloud resource. Accordingly, parsing the metadata by the Natural Language Model provides more comprehensible data and is better suited for cost estimation by the price calculator of the cloud resource. For parsing, any trained large language model which is able to comprehend the metadata can be used. In an embodiment of the present invention, the Natural Language Model may be particularly trained on the language of the software tools to accurately parse the metadata.

The next step S206 is of inputting, the one or more query parameter along with the metadata, to the price calculator. A cloud resource usually provides a price calculator for providing details regarding the charges of the cloud resource and the price calculator can be accessed using its API. At this step S206, by inputting the metadata and the query parameters to the price calculator using its API, an output in the form of cost report can be obtained. The obtained cost report can provide budget estimation, financial planning, monitoring, alerts etc. The API to access the price calculator of the cloud resource can be provided by the cloud resource provider along with necessary documentation for using the API. The input and output format for the API are usually defined in details in the documentation of the API for accessing the price calculator. Once the price report is generated at step S206, the same can then be used in variety of manner for desired financial monitoring of the costs of the cloud resource. For instance, the cost report can be used for estimating charges of utilizing the cloud resource. Particularly, charges mentioned in the cost report can provide an indication of the costs which may occur for utilizing the cloud resource with the given programming data of the software tools. The APIs of the software tools can provide instantaneous programming data and hence, the cost report generated can also provide a latest budget estimate. Further, as the programming data is directly fetched from the software tools, there is no scope of human error, as compared to conventional systems in which programmer would provide the programming data. Still further, the APIs of the software tools and of the pricing calculator can be invoked when desired and hence provide the cost estimate in a timely manner.

In an embodiment of the present invention, in addition to the query parameter, some static parameters are also inputted to the price calculator of the cloud resource. Such static parameters can be standard values to be inputted to the price calculator like number of months, number of logins etc., which may be fixed and need not be extracted from the programming data of the software tool. Such static parameters may be defined for a user and depending upon the user accessing the price calculator, such fields can be inputted to the price calculator. The static parameter can be separately updated by an authorized user and/or can be directly retrieved from a separate server storing such user-based information.

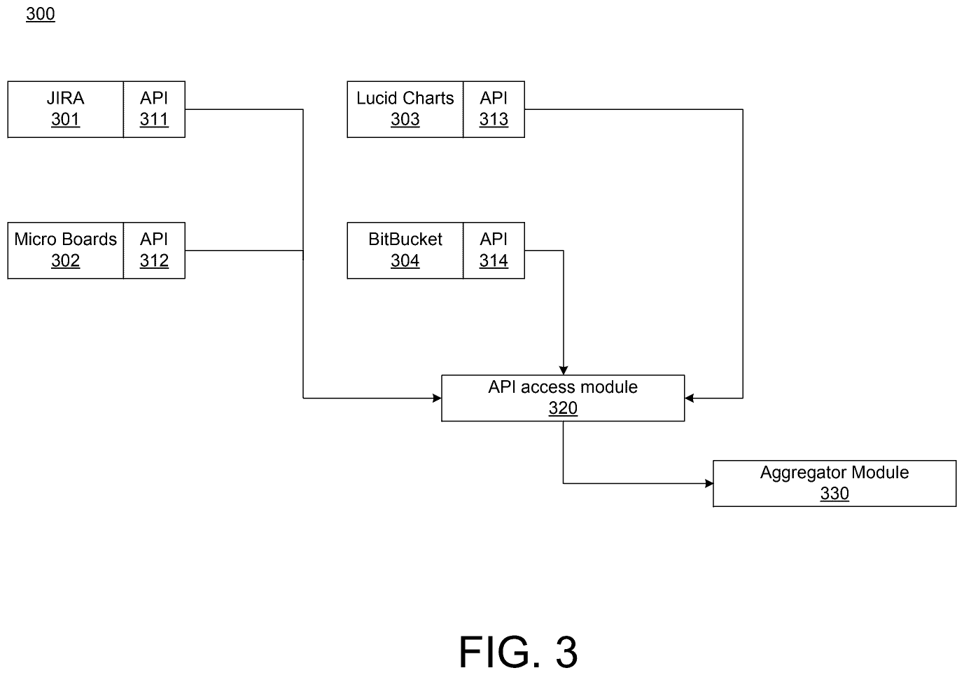

In an exemplary embodiment of the proposed invention, the system may be used for estimating cost of utilizing a cloud resource. FIG. 3 illustrates a system for identifying all software tools which are associated with the cloud resource, extracting programming data of the software tools and combining the extracted programming data to form a master dataset.

The system 300 proposed in the present invention identifies software tool which developers may be using to add new functionalities to a product. The software tools like JIRA 301, MIRO boards 302, Lucid Charts 303, Bitbucket 304, etc., are typically used by software developers. Such software tools also have their respective APIs as shown in FIG. 3, i.e. JIRA API 311, MIRO boards API 312, Lucid Charts API 313 and Bitbucket API 314. The coding data within these software tools can provide details regarding the utilization of the cloud resources based on programming data of these software tool. The system 300 involves identification of relevant software tools which may be associated with utilization of cloud resource. Such identification provides programming data relevant to utilization of cloud resource as not all software tools may have relevant details regarding utilization of cloud resource. Those software tools having programming data regarding utilization of cloud resource are relevant for the present system 300. This identification can be based on look-up table providing such details about each software tool or this identification may be made by querying each software tool and retrieving this information. Once all relevant software tools associated with the cloud resource are identified, the system 300 then retrieves programming data from each of these software tools.

As shown in FIG. 3, the programming data of these various software tools is being retrieved by their respective APIs, however, the invention is not limited to retrieval of programming data via APIs and any other method or technique of retrieving the programming data of the software tools may be utilized. For each software tool from which the programming data is being retrieved, a corresponding API will have to be configured. The API for the extracting can be pre-defined or may be customized for the present implementation is and the present invention is not limited by the implementation or configuration of the API of the software tool. Once the programming data of each of the identified software tool is retrieved by API access module 320, the implementation of the system 300 proposed in the present invention involves combining the programming data of each of the identified software tool by aggregator module 330. The API access module 320 can be further configured to identify if an API for a software tool is available for retrieving the programming data. In case such an API is available, the programming data can be directly retrieved by the API access module 320. If an API is not available, the module may look for any other possible interface or database for retrieval of desired programming data of the software tool.

The retrieval and aggregation of the programming data can be done within a single module using TF-IDF algorithms or other Topic modelling techniques, such that data is extracted based on correlation with the cloud resource. Depending upon the software tool from which the data is being retrieved, different topic modelling techniques may be utilized. The aggregating the programming data from various software tools allows forming of a large dataset of the programming data from various software tools. This large dataset contains information regarding the new functionalities being added to a product and can then be utilized to estimate costs and/or financial planning for utilizing the cloud resource. The APIs of the software tools can provide an UpToDate programming data and can be invoked when desired. The system 300 can also be configured to periodically run the APIs and, retrieve and aggregate the programming data of various software tools.

In an embodiment of the present invention, various APIs can be customized to not only retrieve the programming data at the API access module 320, but also directly retrieve metadata of the programming data of the software tool. Such metadata provide relevant invention regarding values needed for estimating cost of utilizing a cloud resource. As per this embodiment, the retrieved metadata is then passed through the aggregator module 330.

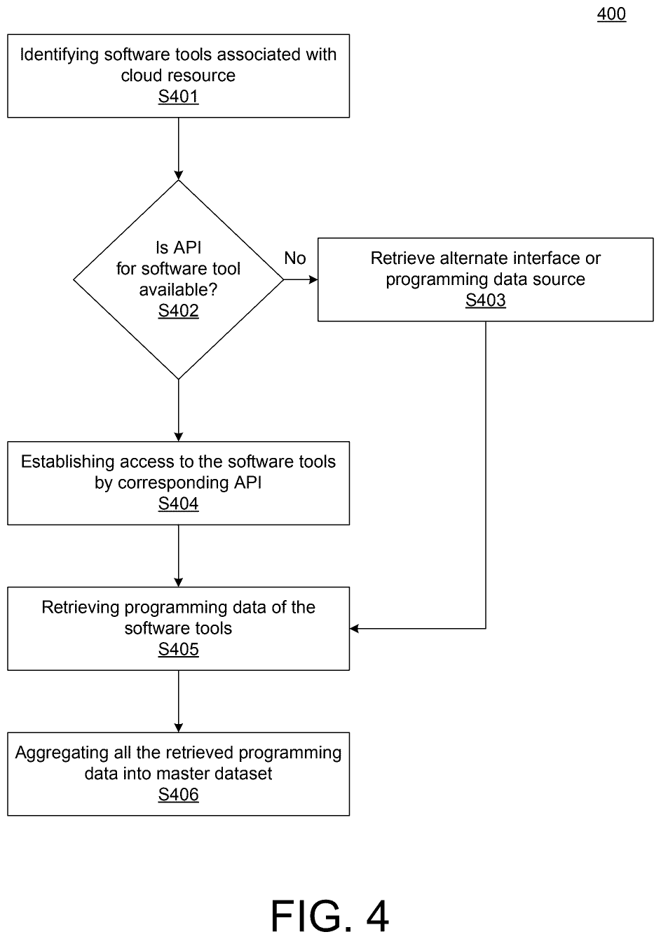

FIG. 4 illustrates a flowchart of the steps executed by a method for identifying all software tools which are associated with the cloud resource, extracting programming data of the software tools and combining the extracted programming data to form a master dataset. Step S401 involves identifying the software tool associated with the cloud resource. Each of the software tool may be independent and unrelated to other software tools. There may be plurality of software tools like JIRA, Confluence, Bitbucket, Lucid Charts, MIRO boards etc., which are associated with the cloud resource utilization. Also, each of software tools has its own data providing details regarding the programming done by software developers. Programming data of these software tools can provide details regarding the utilization of the cloud resources as expected upon implementation of this programming data of these software tool.

Identification of relevant programming tool at step S401 is important as all software tools will not be containing programming data relevant to utilization of the cloud resource. Software tools having programming data about utilization of cloud resource are relevant for the present method 400 and such identification may be made by querying each software tool and retrieving this information. The identification step may be based on look-up table providing relevant details about each software tool. Once all relevant software tools associated with the cloud resource are identified, the next requirement it to retrieve the programming data from each of these software tools. The programming data of each of the software tool may be retrieved by their respective API. However, the API for each software may not be readily available for accessing the programming data.

Step S402 involves identifying if an API for a software tool is available for retrieving the programming data. In case such an API is available, the programming data can be directly establish retrieved by establishing an access to the software tool using its API at step S404. If an API is not available, the method looks for any other possible interface or database (or data source) for retrieval of desired programming data at step S403. Based on identification of such alternatives, the programming data of the software tools is directly retrieved at step S405, as shown in FIG. 4. The API for the extracting can be readymade or may be customized for the present implementation is and the present invention is not limited by the implementation or configuration of the API of the software tool. Alternatively, the programming data of each of the software tool may be retrieved from a copy directly available for access by the present method and the present invention is not limited to the retrieval of the programming data.

Upon retrieval of the programming data of each of the identified software tool, the method involves aggregating all the retrieved programming data into master dataset at step S406. The aggregating or combining the programming data ensures forming of a large dataset of the programming data from various software tools. Such large dataset provides information regarding the new functionalities being added and can then be utilized to estimate costs of utilizing cloud resources. The extraction of data can be based on correlation with the cloud resource. Depending upon the software tool from which the data is being retrieved, different topic modelling techniques may be utilized and the present invention is not limited to a particularly extraction or retrieval algorithm/technique. Once the master dataset is generated, it may then be used for providing cost estimate of utilizing a cloud resource by using price calculator of the cloud resource. The price calculator may provide report having details of the functionality or service of the cloud resource and corresponding budget. The format of the cost report may be modified at the end of the price calculator or at user end. The report may group similar or related services together, or in same color for ease of view and identification. The present invention is not limited by the format or presentation of the report and any suitable format may be utilized for the reporting. Further, the cost report may also have additional fields providing further details regarding the services and their budgets. The report may have details of the services of the cloud resource like, migration, gateway, watch services and their corresponding charges in a given currency.

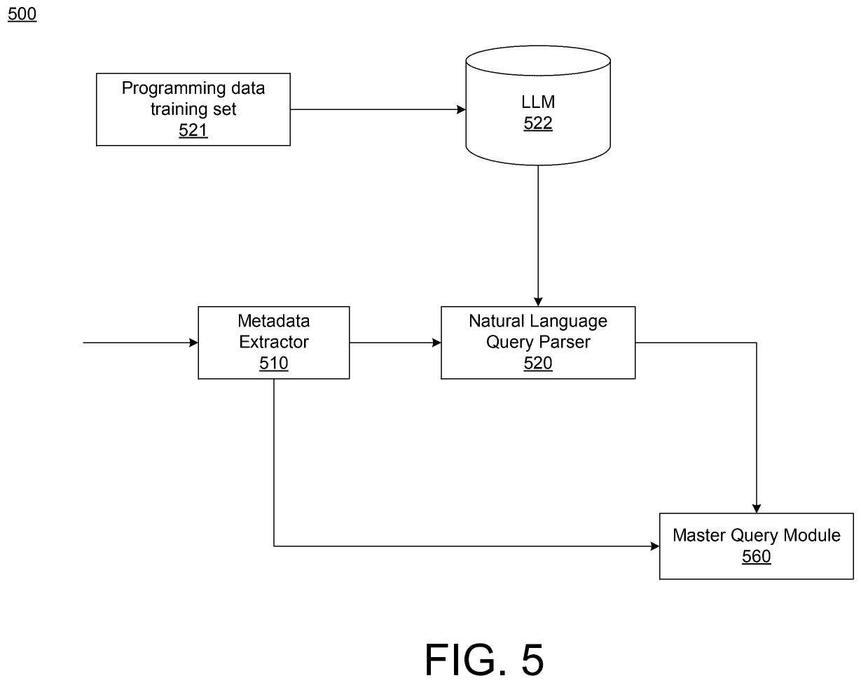

In certain exemplary embodiments of the present invention, extraction of metadata and parsing it to generate query parameters can performed as a standalone system. FIG. 5 illustrates such a system 500 for generation of a master query by extraction of metadata and parsing it to generate query parameters. Based on a large dataset, obtained by aggregating of programming data of one or more software tools, the system 500 is configured to extract metadata, by metadata extractor 510 as shown in FIG. 5. The metadata contains information relevant regarding utilization of the cloud resource. This is important as the master dataset may contain programming data of various software tools, which may not be relevant for the utilization of the cloud resource. As the metadata comprises information relevant to estimating cost of the cloud resource, the metadata can be inputted to a price calculator of the cloud resource to obtain a cost estimate. The metadata may provide values of the fields of the price calculator like location/region, number of severs, number of hours of use per server etc., depending upon the type of service of the cloud resource is being availed, the price calculator will ask for corresponding inputs to provide a cost estimate and such input values are provided from the metadata. As an example, a storage cloud resource will have different inputs and a different price calculation logic, as compared to a migration service cloud resource.

Once the metadata is extracted by the Metadata Extractor 510, it is parsed by a Natural Language Query Parser 520 as shown in FIG. 5. While the metadata extracted contains relevant invention regarding utilization of the cloud resource, the same may not be comprehensible to be fed into a pricing calculator to obtain the cost estimate. Therefore, the metadata can be parsed by the Natural Language Query Parser 520 to obtain more comprehensible data which can then be inputted to the price calculator to obtain the cost estimate. The Natural Language Query Parser 520 can be based on any trained large language model (LLM) 522 which is able to comprehend the metadata. The LLM may be particularly trained on the Programming data Training set 521 to allow the Natural Language Query Parser 520 to accurately parse the metadata. The parsed metadata directly provides query parameters. As per this embodiment, the metadata and the query parameters can be combined at master query module 560 to obtain a master query for feeding to a price calculator of the cloud resource. By inputting the master query to a price calculator of the cloud resource, cost estimate, typically in a form a cost report can be obtained. The extraction of metadata can be based on a Topic modelling technique, such that correlation with the cloud resource can be used for such extraction. The system 500 can also be configured to periodically extract the metadata, parse the metadata and obtain master query, say once every three months.

In an embodiment of the present invention, in addition to the master query, some static parameters are also inputted to the price calculator of the cloud resource. Such static parameters may be defined for a user. Static parameters can be standard values to be inputted to the price calculator like number of months, number of logins etc., which may be fixed and need not be extracted from the programming data of the software tool. The static parameter can be separately updated by an authorized user and/or can be directly retrieved from a separate server configured with a processor and a memory. The processor should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein. Also, memory may be non-transitory and may include, for example, one or more volatile and/or non-volatile memories. In some embodiments, the memory includes or embodies an electronic storage device (e.g., a computer readable storage medium). In some embodiments, the memory is configured to store information, data, content, applications, instructions, or the like, for enabling processor to carry out various operations and/or functions in accordance with example embodiments of the present disclosure.

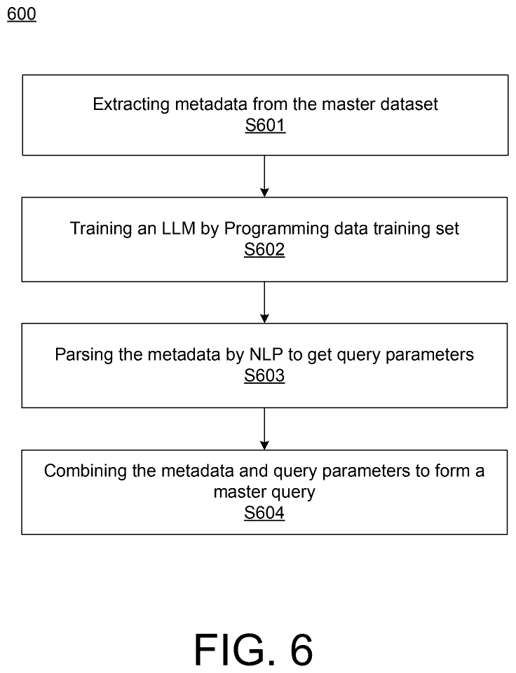

FIG. 6 illustrates a flowchart of the steps executed by a method for generation of a master query, by extraction of metadata and parsing it to generate query parameters. Step S601 involves extraction of metadata from mater dataset. The metadata contains information relevant regarding utilization of cloud resource. This step is relevant as the master dataset may contain programming data, which may not be relevant for the utilization of cloud resource. This step of extraction of metadata ensures that only relevant information relating to utilization of cloud resource is captured. The extraction of metadata can be based on a Topic modelling technique, such that correlation with the cloud resource can be used for such extraction.

Next step S602 is to train a model for natural language processing. This can be done by a trained large language model (LLM) which is able to comprehend the metadata. The LLM may be particularly trained on the Programming data Training set to ensure accurate parsing of the metadata. Any known training technique of training an LLM known in the art may be employed so that the LLM is able to parse the metadata so as to be able to extract fields which can be inputted to the price calculator of the cloud resource and the present invention is not limited by the features or training of the LLM.

Once the metadata is extracted and the model for natural language processing is trained, the next step S603 is parsing of the metadata by a natural language model, to obtain one or more query parameter. This step is performed as even though the metadata extracted contains relevant invention regarding utilization of the cloud resource, the same may not be comprehensible for cost estimation using a pricing calculator of the cloud resource. Accordingly, parsing the metadata by the model for natural language processing provides more comprehensible data and is better suited for cost estimation using the pricing calculator of the cloud resource.

Next step S604 is combining the metadata and the query parameters into a master query for feeding to the price calculator of the cloud resource. By inputting the master query to the price calculator of the cloud resource, cost estimate, in a form a cost report can be obtained. In an embodiment of the present invention, in addition to the master query, some static parameters are also inputted to the price calculator of the cloud resource. Such static parameters can be standard values to be inputted to the price calculator like number of months, number of logins etc., which may be fixed and need not be extracted from the programming data of the software tool. Such static parameters may be defined for a user. The static parameter can be separately updated by an authorized user and/or can be directly retrieved from a separate server.

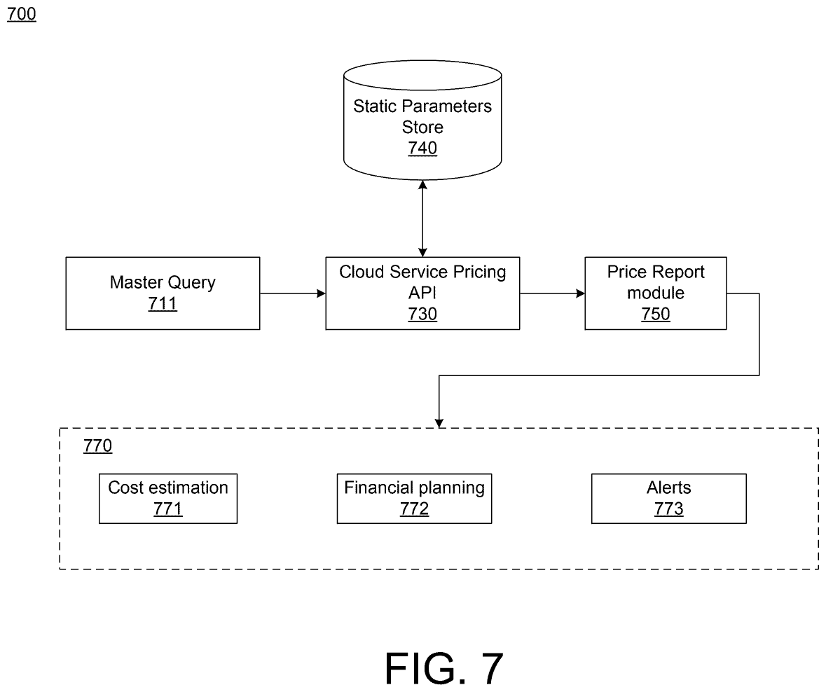

FIG. 7 illustrates a block diagram of a system 700 for generation of price report relating to utilization of a cloud resource and providing overall financial monitoring of the cloud resource charges, in accordance with an embodiment of the present invention. The system 700 receives a master query 711 as an input. The master query 711 is a combination of metadata of programming data of software tools associated with the cloud resource and a parsed metadata. As per the present system 700, the master query 711 is fed to a price calculator of a cloud resource. In an embodiment of the present invention, the price calculator of the cloud resource can be accessed by a Cloud Service Pricing API 730, as shown in FIG. 7. The system 700 of FIG. 7 obtains the cost estimate by invoking the price calculator using Cloud Service Pricing API 730 and inputting the master query to the Cloud Service Pricing API 730. Based on this input, the Cloud Service Pricing API 730 provides a price report at the price report module 750. The obtained price report can then be used for estimation, planning, raising alerts etc., as desired. API to invoke a price calculator is typically made available by provider of the cloud resource along with necessary documentation for invoking the API.

The Cloud Service Pricing API 730 generates the cost report based on the master query as input. In an embodiment of the present invention, in addition to the master query 711, some static parameters are also inputted to the Cloud Service Pricing API 730 by the static parameter store 740. Such static parameters may be some standard values like region, number of months, number of logins etc., which may be fixed and pre-defined for a given user. Depending upon the user accessing the price calculator, such fields can be obtained from the static parameter store 740 and dynamic fields are provided by the master query. The fields in the static parameter store 740 can be separately updated by the user the fields from the static parameter store 740 may not be used for a given user or a given type of functionality for which price calculator is being invoked.

The Cloud Service Pricing API 730 provides the cost report as output. The report may be a spreadsheet providing details of the functionality of the cloud resource and corresponding budget in a given currency. The cost report may also have additional fields further detailing the functionality and the budgets. For instance, the report may have details of the services of the cloud resource and their corresponding charges in a given currency. The report may also group similar or related services together. Further, the report may have multiple sheets providing not only the current, but also historical budgets to provide user with additional information. The price report module 750 is providing the cost report, which can be used for financial monitoring by financial monitoring module 770. The financial monitoring module 770 may have several implementations in the form of cost estimation 771, financial planning 772, alerts 773 etc. Also, the price report can also be saved by the system 700 in a desired format. Each file can be duly timestamped providing ease of future access and identification. Also, the price report format may be dependent on the user, being pre-set for each user.

Once the price report is generated by the system 700 of FIG. 7, the same can be used in variety of manners to achieve better financial tracking and planning under the financial monitoring module 770. Firstly, the cost report can be used for estimating charges of utilizing the cloud resource. Charges mentioned in the cost report can provide an indication of the charges which may occur for utilizing the cloud resource with the given programming data of the software tools. The cost report can also be used for financial planning 772 the budget of utilizing a cloud resource. By comparing the previous and current cost report, a user can track a change in the costs and/or estimated budget. The change may be tracked for the total budget or for budget of any particular service within the cost report. The user may even compare multiple previous cost report to monitor the cost trend and use them to project future costs. Any unreasonable increase in the budget can be reported and analyzed further, as desired. Such increase in the budget can also be used for triggering alert 773 to concerned users. The criteria for the tracking and/or raising alert may be pre-set within the system. Also, the alert may be for a particular service within the cost report and may not be triggered for all services even if they exceed the limit. These alerts can be placed for some services which are in high demand to better plan the budget.

The change in budget in different cost report can also allow a user to track new features which the developers may be implementing providing better financial planning 772. Accordingly, in an embodiment of the present invention the change in budget may be used for identifying new features being implemented. Particularly, in case there is an increase in budget based on the cost report generated by the price calculator of the cloud resource, further analysis may be performed for identifying the applicable feature(s) of a product responsible for this budget increase. The cost report can further be used for updating the budget allocation for utilizing the cloud resource. For instance, based on a latest cost report it is identified that the projected budget will increase substantially, the budget allocation for the cloud resource itself can be updated so that the cloud services can continue without any issue of the added costs. Particularly, for an organization, based on the estimated increase in the budget of utilization of the cloud resource, necessary approvals, say from finance team, managements etc., can be timely taken for smooth operation of the product with new functionalities.

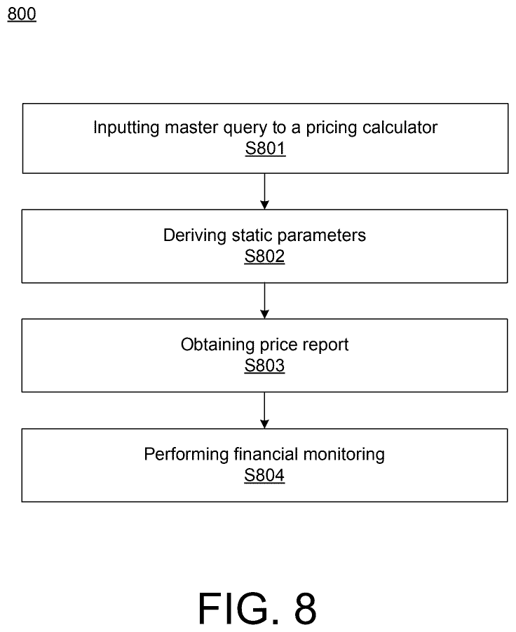

FIG. 8 illustrates the steps executed by a method 800 for generating price report relating to utilization of a cloud resource and providing overall financial monitoring of the cloud resource charges, in accordance with an embodiment of the present invention. Step S801 involves inputting a master query to the price calculator of the cloud resource. The master query is a combination of metadata of programming data of software tools associated with the cloud resource and a parsed metadata. Further, at step S802, some static parameters are also derived as inputs to the price calculator of the cloud resource. Such static parameters may be some standard values like region, number of months, number of logins etc., which may be fixed and pre-defined for a given user. Depending upon the user accessing the price calculator, such fields can be obtained from a static parameter store and dynamic fields are provided by the master query. The fields in the static parameter store can be separately updated by the user the fields from the static parameter store may not be used for a given user or a given type of functionality for which price calculator is being invoked.

Next at step S803, the master query and the static parameters are fed to the price calculator of the cloud resource. The method 800 involves obtaining the cost estimate by invoking the price calculator and inputting the master query along with the static parameters to the cloud resource. The obtained price report can then be used for estimation, planning, raising alerts etc., as desired. The price report may have fields detailing the functionality and the budgets of the cloud resource. For instance, the report may have details of the services of the cloud resource and their corresponding charges in a given currency. The report may also group similar or related services together. Further, the report may have multiple sheets providing not only the current, but also historical budgets to provide user with additional information.

The price report can be used for financial monitoring in step S804. The financial monitoring may include cost estimation, financial planning, alerts etc., the cost report can be used for estimating charges of utilizing the cloud resource. For instance, charges mentioned in the cost report can give an indication of the charges which may occur for utilizing the cloud resource with the given programming data of the software tools. The cost report can also be used for financial planning the budget of utilizing a cloud resource. By comparing the previous and current cost report, a user can track a change in the costs. The change may be tracked for the total budget or for budget of any particular service within the cost report. Any unpredictable increase in the budget can be reported, analyzed and tracked, as desired. The cost report can also be used for updating the budget allocation for utilizing the cloud resource. For instance, based on a latest cost report it is identified that the projected budget will increase substantially, the budget allocation for the cloud resource itself can be updated so that the cloud services can continue without any issue of the added costs. Still further any increase in the budget can also be used for triggering one or more alerts to concerned users. The criteria for the alerts may be pre-set and the alerts can be placed for some specific services based on the user, services, product or a combination thereof.

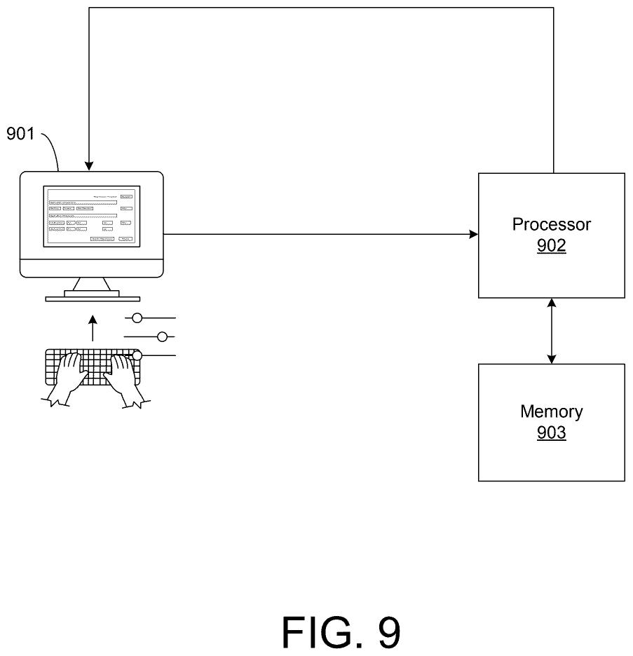

The cost estimation of utilizing a cloud resource in accordance with an embodiment of the present invention may be performed based on inputs provided by the user to the system. The input may be provided to the system at a user device. The user device may be any computing device such as a laptop, computer, mobile phone etc. The user device acts as an interface of the system for receiving the input from the user. The input from the user may include command for accessing APIs of various software tools, retrieving programming data, retrieving metadata, etc. In one embodiment, the instructions may be provided in the form of options selected from a plurality of drop-down lists, check boxes etc. FIG. 9 illustrates a user interface for cost estimation of utilizing a cloud resource, in accordance with an embodiment of the present invention.

The user may access his user interface 901 and the instructions provided by the user are provided as input for providing cost estimation of utilizing a cloud resource. The user input is provided to a processor 902 which is connected to a memory 903. The processor 902 may be a part of the cloud resource. Alternatively, processor 902 may be a separately installed on a machine not connected to the cloud resource. Based on the user inputs sent to the processor 902, the user interface may be updated based on instructions received from the processor 902 in accordance with instructions stored in a memory 903, thus providing a latest cost estimate. In an embodiment, details of the software tools and their programming data may be stored within the memory of the processor, and may be referred to for providing interactive user interface. Processor 902 may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor 902 includes hardware, software, firmware, and/or a combination thereof that performs one or more operations described herein. The processor 902 may be configured to execute instructions stored in the memory 903 or otherwise accessible to the processor. Alternatively, the processor 902 may be configured to execute hard-coded functionality. As such, whether configured by hardware or software methods, or by a combination thereof, processor 902 may represent an entity (e.g., physically embodied in circuitry) capable of performing operations according to embodiments of the present disclosure while configured accordingly. Alternatively, the processor 902 may be embodied as an executor of software instructions, and the instructions may specifically configure the processor 902 to perform the various algorithms embodied in one or more operations described herein when such instructions are executed. In some embodiments, the processor 902 includes hardware, software, firmware, and/or a combination thereof that performs one or more operations described herein. In some embodiments, the processor 902 (and/or co-processor or any other processing circuitry assisting or otherwise associated with the processor) is/are in communication with the memory 903 via a bus for passing information. Memory 903 may be non-transitory and may include, for example, one or more volatile and/or non-volatile memories. In some embodiments, the memory 903 includes or embodies an electronic storage device (e.g., a computer readable storage medium). In some embodiments, the memory 903 is configured to store information, data, content, applications, instructions, or the like, for enabling processor 902 to carry out various operations and/or functions in accordance with example embodiments of the present disclosure.

Specific input instructions provided by a user for cost estimation of utilizing a cloud resource may also be based on use of specific input tools or methods. The input/output unit 901 may be in communication with the processor 902. The input/output unit 901 may comprise one or more user interface(s). In some embodiments, a user interface may include a display that comprises the interface(s) rendered as a web user interface, an application user interface, a user device, a backend system, or the like. In some embodiments, the input/output unit 901 also includes a keyboard, a mouse, a joystick, a touch screen, touch areas, soft keys a microphone, a speaker, or other input/output mechanisms. The processor 902 and/or input/output unit 901 comprising the processor may be configured to control one or more operations and/or functions of one or more user interface elements through computer program instructions (e.g., software and/or firmware) stored on a memory accessible to the processor (e.g., memory 903, and/or the like). In some embodiments, the input/output unit 901 includes or utilizes a user-facing application to provide input/output functionality.

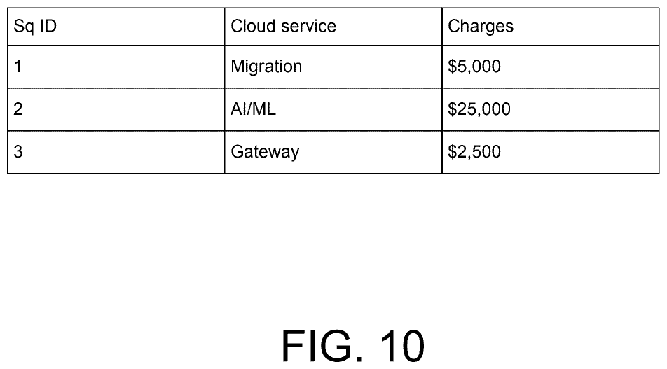

FIG. 10 represents a typical cost report generated by the price calculator of a cloud resource. In an embodiment of the present invention, the metadata of programming data of a software tool is inputted to a pricing calculator of the cloud resource to generate a price report. The generated price report can then be utilized to estimate the cost of utilizing the cloud resource, track budgets, raise alerts etc. The report may be a spreadsheet, similar to the report shown in FIG. 10, providing details of the functionality or service of the cloud resource and corresponding budget in a given currency. The format of the cost report may be modified at the pricing calculator end or subsequently to meet the requirement of the user. The cost report may also have additional fields further detailing the services and the budgets. The report may have details of the services of the cloud resource like, migration, gateway, watch services and their corresponding charges in a given currency. The report may also group similar or related services together or in same color for ease of view and identification.

The present invention is not limited by the format or presentation of the report and any suitable format may be utilized for this reporting. Further, the report may have multiple sheets providing not only the current, but also historical budgets to provide user with additional information. Also, the price report will not only be available for viewings, but can also be saved by the system in a desired format like excel sheet, word file, pdf etc. Also, the price report format may be dependent on the user, being pre-set for each user. This will provide each user with price report in a format as desired hence, providing only relevant information. The cost report can also be used for tracking and planning the budget of utilizing a cloud resource. By comparing the previous and current cost report, a user can track a change in the costs and/or estimated budget. The change may be tracked for the total budget or for budget of any particular service within the cost report. The user may even compare multiple previous cost report to monitor trends and use them to project future costs. Any change in the budget can be reported and/or analyzed further as desired. Further, change in the budget can also be used for triggering alert(s) to concerned users. The criteria for the alerts may be decided in advance or may be modified when desired. Further, the alerts may be for a particular service within the cost report and may not be triggered for all services even if they exceed the limit. These alerts can be placed for some specific services which are of relevance to an organization, say migration cloud services only, so as to better plan the budget for such services only.

The change in budget in different cost report can also allow a user to track new features which will consume the cloud resource. A change in budget may be used for identifying new features being implemented based on the cost report of FIG. 10. In case there is an increase in budget based on a cost report generated, further analysis may be performed. Also, tracking of features of a software product may also be implemented in the form of alerts to some specific users. The cost report can further be used for updating the budget allocation for utilizing the cloud resource. For instance, based on a latest cost report it is identified that the projected budget will increase substantially, the budget allocation for the cloud resource itself can be updated so that the cloud services can continue without any issue of the increased costs. In view of the estimated increase, necessary budget approvals can be timely obtained so that cloud services are be continuously used without interruption.

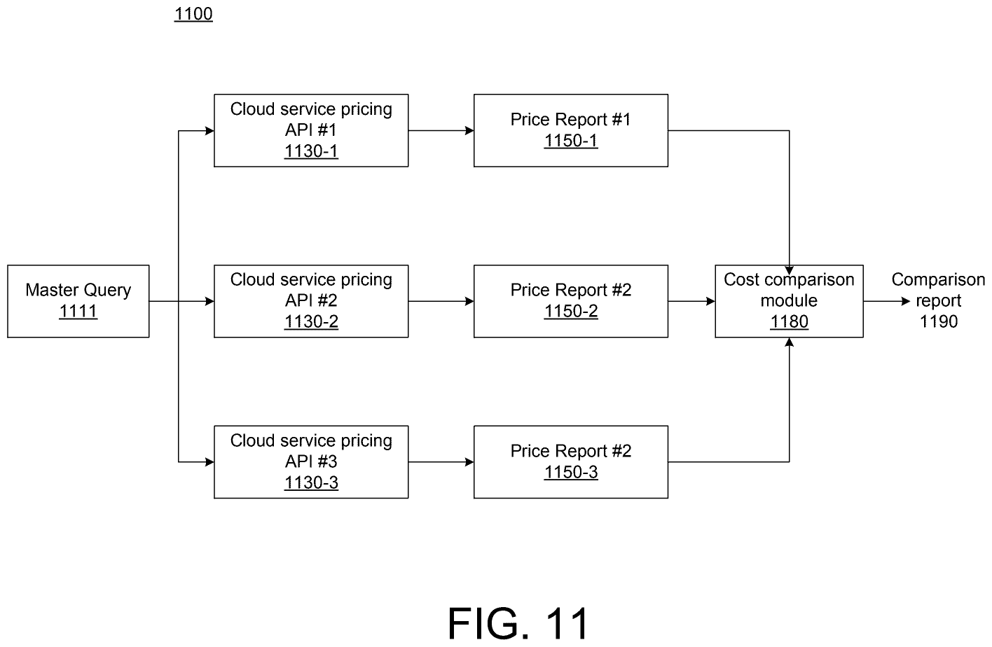

FIG. 11 illustrates a block diagram of a system 1100 for generation of price report of multiple cloud resources and comparison amongst the price report of multiple cloud resources, in accordance with an embodiment of the present invention. The system 1100 receives a master query 1111 as an input. The master query 1111 is a combination of metadata of programming data of software tools associated with the cloud resource and a parsed metadata. As per the present system 1100, the master query 1111 is fed to price calculators of multiple cloud resources. In an embodiment of the present invention, the price calculator of each of the cloud resource can be accessed by their respective Cloud Service Pricing APIs 1130-1, 1130-2, 1130-3, as shown in FIG. 11. The system 1100 of FIG. 11 obtains the cost estimate by invoking the price calculator using the Cloud Service Pricing APIs 1130-1, 1130-2, 1130-3 inputting the master query to the Cloud Service Pricing APIs. Based on this input, the Cloud Service Pricing APIs 1130-1, 1130-2, 1130-3 provide their respective price report at the price report modules 1150-1, 1150-2 1150-3. The obtained price report can then be compared at the cost comparison module 1180 which provides an output as comparison report 1190.

As the cost of utilizing cloud services can substantially vary between various cloud service providers a comparison between various cost report can provide better planning and choice of a cloud resource provider by an organization using the cloud services. As per system 1100 of FIG. 11, once the master query, having details regarding the programming data of various tools associated with cloud resource are known, the present system can invoke price calculator of multiple cloud resources and derive their respective price report. The calling of the APIs of each price calculator can be done simultaneously or sequentially, and the present invention is not limited by the method of accessing of the price calculator of multiple cloud resources.

Still further, static parameter of each price calculator can also be utilized to provide standard values like number of logins, region etc. The static parameter for price calculator of each cloud resource may be common or separate. Once price report of each of the cloud resource is derived, a comparison can be made on the total cost to assess the most cost-effective cloud resource provider. Such comparison may not be limited to total cost, rather individual services can also be compared to provide details regarding the most cost-effective cloud resource provider for each service. This comparison can allow for development or finance team to select the best suited single cloud resource provider or best suited clouds service provider for each service.

In an embodiment of the present invention, the system of FIG. 11 allows for comparison of price report of various cloud service providers of not only current master dataset, but also for historical price reports for each of the various cloud resource provider, to provide a user with additional insights. The historical price reports can be duly timestamped providing ease of future access and identification. Based on the comparison, the cost comparison module 1180 can provide comparison in the form of table, charts, heat maps or just plain text. The format of comparison can be modified by a user accessing the system 1100 or the result can be exported/downloaded on a separate device, not part of the system 1100. The API to invoke a price calculator is typically provided by provider of the cloud resource along with necessary documentation for invoking or using the API. Further, while the system 1100 shows APIs for each of the cloud resource, price report of each of the cloud resource provider is available with the master dataset and an API will not require for accessing the process calculator. Still further, as per an alternative embodiment, some of the cloud resource provider have APIs for their price calculator and other cloud resource provider have their price report provided directly with the master dataset.

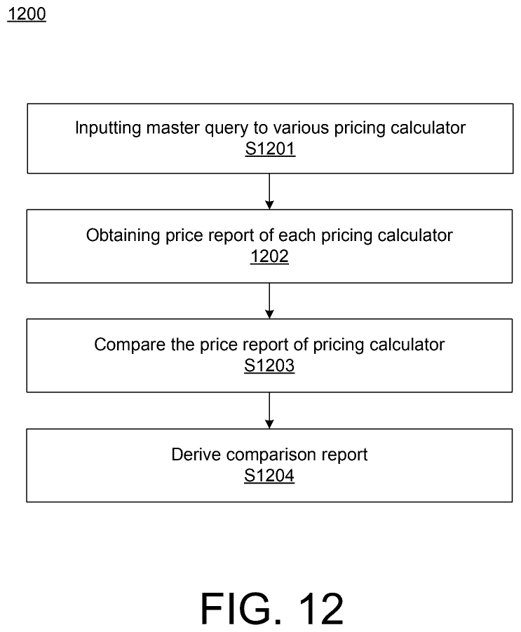

FIG. 12 illustrates the steps executed by the method 1200 for generation of price report of multiple cloud resources and comparison amongst the price report of multiple cloud resources, in accordance with an embodiment of the present invention. Step S1201 involves inputting a master query to a price calculator. The master query is a combination of metadata of programming data of software tools associated with the cloud resource and a parsed metadata. Thereafter, at step S1202, master query is fed to the price calculator of each of the cloud resource. The method 1200 involves obtaining the cost estimate by invoking the price calculator of each of the cloud resource and inputting the master query to each of the cloud resource. The obtained price reports can then be used for comparison and financial planning as desired at Step S1203. The price report may have fields detailing the functionality and the budgets of the cloud resource.

Once price report of each of the cloud resource is derived, a comparison can be made on the total cost to assess the most cost-effective cloud resource provider at Step S1204. Such comparison may not be limited to total cost, rather individual services can also be compared to provide details regarding the most cost-effective cloud resource provider for each service. This comparison can allow for development or finance team to select the best suited single cloud resource provider or best suited clouds service provider for each service. Historical price reports for each of the various cloud resource provider can also be used to provide additional insights.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and methods are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A method for estimating cost of utilizing a cloud resource, comprising:
identifying one or more software tool associated with the cloud resource, wherein the one or more software tool comprises programming data;
retrieving the programming data of each of the one or more software tool;
aggregating the programming data of each of the one or more software tool into a master dataset;
extracting metadata from the master dataset, wherein the metadata comprises one or more fields relevant to utilizing the cloud resource;
parsing the metadata, by a natural language model, to obtain one or more query parameter; and
inputting the metadata and each of the one or more query parameter into a pricing calculator of the cloud resource to generate a price report, wherein the price report is utilized to estimate the cost of utilizing the cloud resource.

2. The method of claim 1, further comprising:
retrieving an existing cost of utilizing the cloud resource, wherein the existing cost is based on a historical utilization of the cloud resource; and
utilizing the existing cost and the estimated cost to calculate a change in budget of utilizing the cloud resource.

3. The method of claim 2, further comprising:
raising one or more alert based on the change in budget of utilizing the cloud resource.

4. The method of claim 1, further comprising:
modifying the one or more price report by inputting one or more static parameter to the pricing calculator of the cloud resource, wherein the one or more static parameter is based on a user accessing the pricing calculator of the cloud resource.

5. The method of claim 1, wherein the retrieving of the programming data and the one or more price report is assisted by one or more Application Programming Interface (API).

6. The method of claim 5, wherein the one or more API is automatically triggered at a user defined time interval.

7. The method of claim 1, wherein the metadata is extracted based on one or more of topic modelling technique.

8. The method of claim 1, wherein the one or more price report is automatically updated based on an update of the master dataset.

9. The method of claim 1, wherein the natural language model is pre-trained based on syntax of the one or more software tool.

10. The method of claim 1, wherein the one or more price report is customizable based on a user input.

11. A system for estimating cost of utilizing a cloud resource, comprising:
one or more processor;
a memory; and
one or more programs stored in the memory, the one or more programs comprising instructions configured to:
identify one or more software tool associated with the cloud resource, wherein the one or more software tool comprises programming data;
retrieve the programming data of each of the one or more software tool;
aggregate the programming data of each of the one or more software tool into a master dataset;
extract metadata from the master dataset, wherein the metadata comprises one or more fields relevant to utilizing the cloud resource;
parse the metadata, by a natural language model, to obtain one or more query parameter; and
input the metadata and each of the one or more query parameter into a pricing calculator of the cloud resource to generate a price report, wherein the price report is utilized to estimate the cost of utilizing the cloud resource.

12. The system of claim 11, wherein the instructions are further configured to:
retrieve an existing cost of utilizing the cloud resource wherein the existing cost is based on a historical utilization of the cloud resource; and
utilize the existing cost and the estimated cost to calculate a change in budget of utilizing the cloud resource.

13. The system of claim 12, wherein the instructions are further configured to:
raise one or more alert based on the change in budget of utilizing the cloud resource.

14. The system of claim 11, wherein the instructions are further configured to:
modify the one or more price report by inputting one or more static parameter to the pricing calculator of the cloud resource, wherein the one or more static parameter is based on a user accessing the pricing calculator of the cloud resource.

15. The system of claim 11, wherein the retrieving of the programming data and the one or more price report is assisted by one or more Application Programming Interface (API).

16. The system of claim 11, wherein the metadata is extracted based on one or more of topic modelling technique.

17. The system of claim 11, wherein the one or more price report is automatically updated based on an update of the master dataset.

18. The system of claim 11, wherein the natural language model is pre-trained based on syntax of the one or more software tool.

19. The system of claim 11, wherein the one or more price report is customizable based on a user input.

20. A non-transitory computer-readable storage medium comprising computer program code for execution by one or more processors of an apparatus, the computer program code configured to, when executed by the one or more processors, causes the apparatus to:
identify one or more software tool associated with a cloud resource, wherein the one or more software tool comprises programming data;
retrieve the programming data of each of the one or more software tool;
aggregate the programming data of each of the one or more software tool into a master dataset;
extract metadata from the master dataset, wherein the metadata comprises one or more fields relevant to utilizing the cloud resource;
parse the metadata, by a natural language model, to obtain one or more query parameter; and
input the metadata and each of the one or more query parameter into a pricing calculator of the cloud resource to generate a price report, wherein the price report is utilized to estimate a cost of utilizing the cloud resource.
